(19) United States
(12) Patent Application Publication
(10) Pub. No.: US 2010/0124955 A1
(43) Pub. Date: May 20, 2010

(54) SLIDING-TYPE PORTABLE TERMINAL

(75) Inventor: SHING-HUEI LIN, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: CHI MEI COMMUNICATION SYSTEMS, INC., Tu-Cheng City (TW)

(21) Appl. No.: 12/468,945

(22) Filed: May 20, 2009

(30) Foreign Application Priority Data
Nov. 17, 2008 (CN) 200810305588.6

(51) Int. Cl. H04M 1/00

(52) U.S. Cl. 455/575.4

(57) ABSTRACT

A sliding-type portable terminal includes a main body, a cover, a driving mechanism, a first magnetic member and a second magnetic member. The cover is slidably connected to the main body. The driving mechanism provides a force to drive the cover to move towards the main body between closed and open states. The first magnetic member is fixed on the main body, and the second magnetic member is fixed on the cover. The first magnetic member and the second magnetic member are attracted to each other, thereby generating a magnetic force making the cover securely engages with the main body when the cover is in a closed state.

### BACKGROUND

1. Technical Field

The present disclosure relates to a sliding-type portable terminal.

2. Description of the Related Art

Generally, a sliding-type portable terminal includes a main body, a cover, and a driving mechanism. The driving mechanism provides an elastic force for sliding the cover relative to the main body between closed and open states.

As illustrated in FIG. 5, a typical sliding-type portable terminal 10 includes a main body 11 and a cover 12 slidably connected to the main body 11. However, the main body 11 and the cover 12 are easily scratched over a period of time, thereby decreasing the engagement precision. In addition, elasticity of elastic components in the portable terminal 10 also deteriorate over repeatedly usage. As a result, the cover 12 may not securely and closely engage with the main body 11, and a side surface 121 of the cover 12 can not be coplanar with a side surface 112 of the main body 11.

Therefore, there is room for improvement within the art.

### BRIEF DESCRIPTION OF THE DRAWINGS

The components in the drawings are not necessarily drawn to scale, the emphasis instead being placed upon clearly illustrating the principles of the present disclosure.

FIG. 1 is an isometric view of an embodiment of a sliding-type portable terminal, including a cover and a main body, in an open state.

FIG. 2 is an exploded, isometric view of the sliding-type portable terminal of FIG 1.

FIG. 3 is an isometric view of the sliding-type portable terminal of FIG. 1 without the top housing and the bottom housing.

FIG. 4 is similar to FIG. 3, but showing a closed state.

FIG. 5 is an isometric view of a typical sliding-type portable terminal in an almost fully closed state.

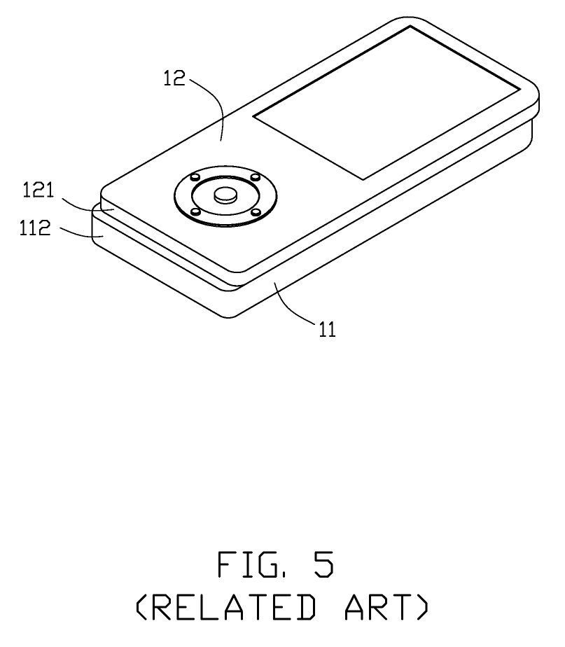

### DETAILED DESCRIPTION

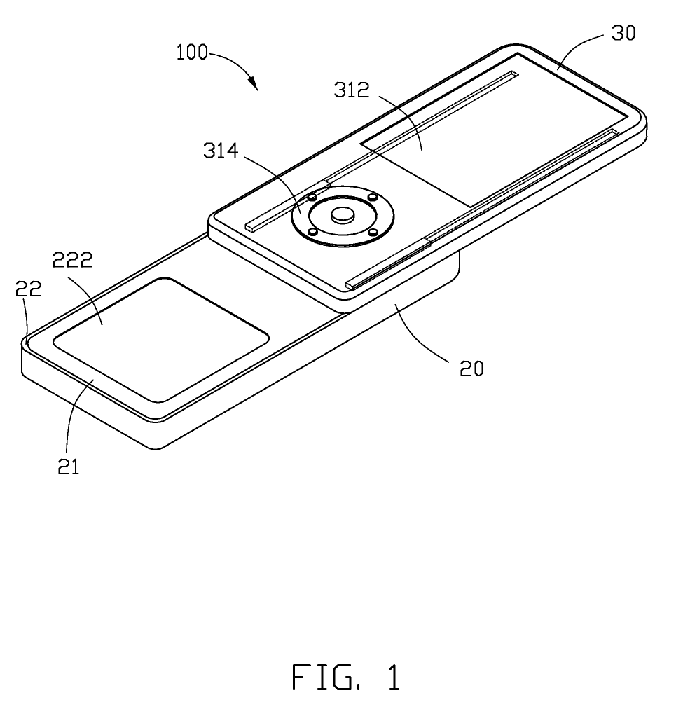

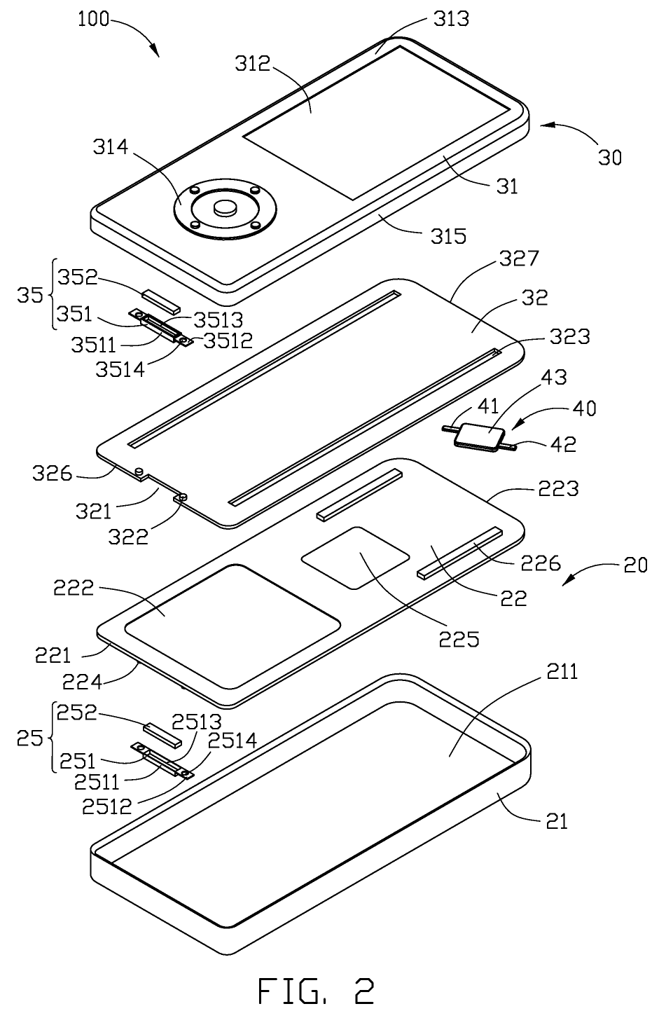

Referring to FIGS. 1 and 2, a sliding-type portable terminal 100 includes a main body 20, a cover 30, a first magnetic module 25, a second magnetic module 35, a driving mechanism 40, and a plurality of electronic components (not shown).

The cover 30 is slidably engaged with the main body 20 via sliding rails 226 and sliding grooves 323 slidably engaged with the sliding rails 226. The sliding rails 226 can be formed on the main body 20 and the sliding grooves 323 can be formed in the cover 30. The driving mechanism 40 is configured to facilitate sliding the cover 30 relative to the main body 20 between closed and open states. The electronic components such as printed circuit board (PCB) and keyboard (not shown) can be received in the main body 20, and a display (not shown) can be received in the cover 30.

The main body 20 includes a bottom housing 21 and a bottom sliding plate 22. The bottom housing 21 defines a cavity 211 for receiving the electronic components. The bottom sliding plate 22 includes a first end 221 and a second end 223 opposite to the first end 221. A keypad 222 can be positioned on the first end 221. The bottom sliding plate 22 forms two first protrusions 224 on a bottom surface thereof. The first protrusions 224 are adjacent to the first end 221. The bottom sliding plate 22 is configured to cover the cavity 211 and defines a groove 225 for receiving the driving mechanism 40. Two parallel sliding rails 226 are formed on a top surface of the bottom sliding plate 22.

The first magnetic module 25 includes a first connecting member 251 and a first magnetic member 252 received in the first connecting member 251. The first magnetic member 251 is elongated and made of magnetic materials. The first connecting member 251 may be made of rubber and includes a connecting portion 2511 and two wing portions 2512 extending symmetrically with respect to the connecting portion 2511. The connecting portion 2511 defines a groove 2513 to receive the first magnetic member 252. Each wing portion 2512 defines a hole 2514 to receive the first protrusion 224, thereby fixing the connecting member 251 to the bottom sliding plate 22.

The cover 30 includes a top housing 31 and a top sliding plate 32. The top housing 31 includes a top wall 313 and a sidewall 315 connected to the top wall 313. The top wall 313 and the sidewall 315 cooperatively define a cavity (not labeled) for receiving the electronic components. The top wall 313 further defines an opening 312 communicated with the cavity. The opening 312 is configured to receive the display. A function keypad 314 may be positioned adjacent to the opening 312.

The top sliding plate 32 includes a first end 326 and a second end 327 opposite to the first end 326. The first end 326 defines a notch 321. The top sliding plate 32 forms two second protrusions 322 on the first end 326. The second protrusions 322 are positioned at two opposite sides of the notch 321 respectively. The top sliding plate 32 is configured to cover the cavity. The top sliding plate 32 defines two parallel sliding grooves 323 slidably and respectively engaged with the parallel sliding rails 226 in the main body 20.

The second magnetic module 35 includes a second connecting member 351 and a second magnetic member 352 received in the second connecting member 351. The second magnetic member 351 is elongated and made of magnetic materials. The second connecting member 351 may be made of rubber and includes a connecting portion 3511 and two wing portions 3512. The connecting portion 3511 defines a groove 3513 to receive the second magnetic member 352. Each wing portion 3512 defines a hole 3514 to receive the second protrusion 322, thereby fixing the second connecting member 351 to the bottom sliding plate 32.

The driving mechanism 40 includes a first connecting end 41, an opposite second connecting end 42, and an elastic module 43 connecting the first connecting end 41 to the second connecting end 42. The elastic module 43 provides an elastic force to drive the first connecting end 41 to move relative to the second connecting end 42.

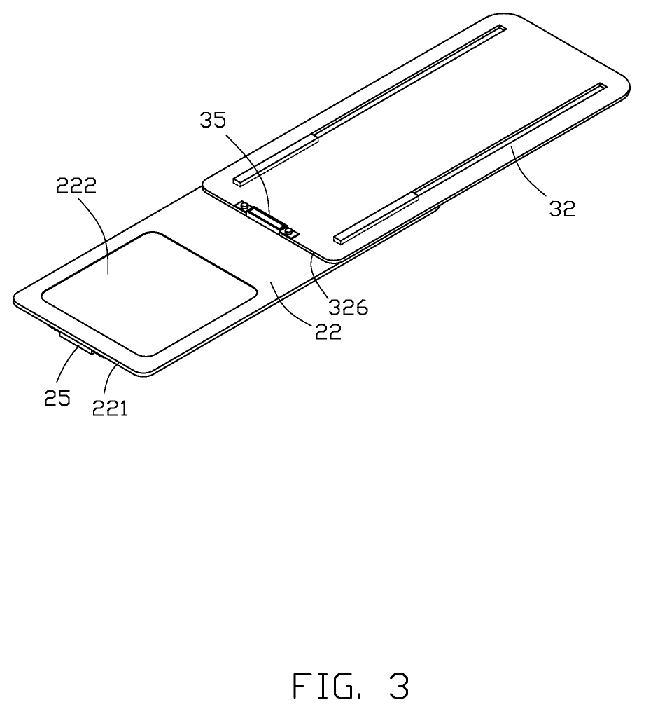

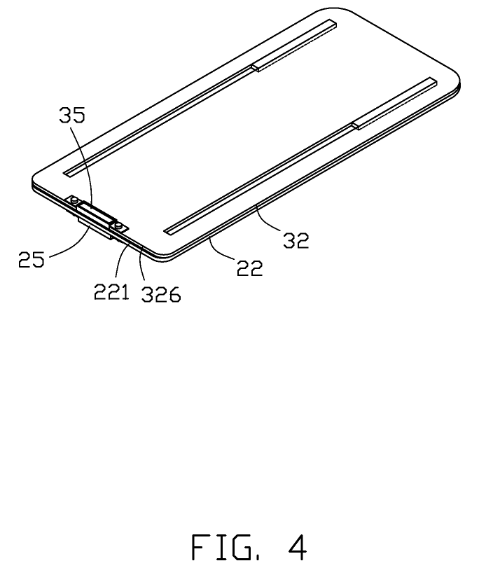

Referring to FIGS. 1 through 4, to assemble the sliding-type portable terminal 100, the first protrusions 224 are inserted into the holes 2514 such that the first magnetic module 25 is fixed on the bottom sliding plate 22. The bottom sliding plate 22 is fixed on the bottom housing 21 in such manner that the bottom sliding plate 22 covers the cavity 211.

The connecting portion 3511 of the second connecting member 351 is inserted into the notch 321, and the two wing portions 3512 engage with the second protrusions 322 correspondingly, thereby the second magnetic module 35 is fixed on the first end 326 of the top sliding plate 32. The top sliding plate 32 is fixed on the top housing 31 in such manner that the top sliding plate 32 covers the cavity defined by the top housing 31.

The driving mechanism 40 is received in the groove 225 of the bottom sliding plate 22. The first connecting end 41 of the driving mechanism 40 is fixed to the top sliding plate 32, and the second connecting end 42 is fixed to the bottom sliding plate 22. The first magnetic member 252 and the second magnetic member 352 are arranged in opposing polarities with respect to each other, thereby a magnetic force is generated between the first magnetic module 25 and the second magnetic module 35, thus, yielding the sliding-type portable terminal 100.

Referring to FIGS. 1 through 4, to close the cover 30, the cover 30 is moved relative to the main body 20, the second magnetic module 35 moves towards the first magnetic module 25. As the distance between the first magnetic module 25 and the second magnetic module 35 decreases, the magnetic force generated between the first magnetic module 25 and the second magnetic module 35 increases. When the cover 30 is in the closed state, the second magnetic module 35 is on top of the first magnetic module 25 and is substantially aligned with the first magnetic module 25 so that the cover 20 securely and closely contacts with the main body 30 by the strong magnetic force. As a result, the first end 326 of the top sliding plate 32 can be substantially aligned with the first end 221 of the bottom sliding plate 22.

To open the cover 30, an external force is applied to slide the cover 30. The elastic module 43 is compressed, accumulating elastic force, and reaches the largest elastic force when the cover 30 is at a predetermined position about mid-way between the closed and open positions. At this time, the elastic force of the elastic module is released and the cover 30 slides semi-automatically along the main body 20 by the elastic force applied by the driving mechanism 40. When the cover 30 is open, due to the distance between the first magnetic module 25 and the second magnetic module 35, the magnetic force generated between the first magnetic module 25 and the second magnetic module 35 does not affect the position of the cover 30, thus the cover 30 is capable of securely maintaining in the open state.

It should be understood that, one of the first magnetic member 251 and the second magnetic member 351 may be made of ferromagnetic materials, such as iron, cobalt, nickel and their combinations, and the other one may be made of magnet.

It should be understood that, the magnetic module 25 may be in contact with the second end 327 of the top sliding plate 32, and the second magnetic module 35 may be in contact with the second end 223 of the bottom sliding plate 22 accordingly. In addition, the first magnetic member 25 and the second magnetic module 35 also can be respectively positioned on the middle of the main body 20 and the cover 30. When the cover 30 moves to the closed state relative to the main body 20, the cover 20 is capable of contacting with the main body 30 closely and securely by the magnetic force generated between the first magnetic module 25 and the second magnetic module 35.

It is believed that the present embodiments and their advantages will be understood from the foregoing description, and it will be apparent that various changes may be made thereto without departing from the spirit and scope of the embodiments or sacrificing all of its material advantages, the examples hereinbefore described merely being preferred or exemplary embodiments.

What is claimed is:

1. A sliding-type portable terminal, comprising:
a main body;
a cover slidably connected to the main body;
a driving mechanism connected to the main body and the cover for providing a force to drive the cover to move towards the main body;
a first magnetic member fixed on the main body; and
a second magnetic member fixed on the cover, wherein the first magnetic member and the second magnetic member are arranged in opposing polarities with respect to each other, such that a magnetic force is generated between the first magnetic member and the second magnetic member, thus the cover securely engages with the main body.

2. The sliding-type portable terminal of claim 1, wherein one of the first magnetic member and the second magnetic member is made of ferromagnetic materials, and the other magnetic member is a magnet.

3. The sliding-type portable terminal of claim 1, wherein the second magnetic member is on top of the first magnetic member and is substantially aligned with the first magnetic member when the cover is in a closed state.

4. The sliding-type portable terminal of claim 1, wherein the main body further comprises a bottom housing and a bottom sliding plate, the bottom housing defines an cavity, the bottom sliding plate covers the cavity, the first magnetic member is fixed to the bottom sliding plate.

5. The sliding-type portable terminal of claim 4, wherein the sliding-type portable terminal further comprises a first connecting member configured to receive the first magnetic member, the first connecting member is fixed to the bottom sliding plate.

6. The sliding-type portable terminal of claim 5, wherein the first connecting member is made of rubber.

7. The sliding-type portable terminal of claim 5, wherein the first connecting member comprises a connecting portion, the connecting portion defines a groove to receive the first magnetic member.

8. The sliding-type portable terminal of claim 7, wherein the first connecting member further comprises two wing portions extending symmetrically with respect to the connecting portion, the bottom sliding plate forms two first protrusions on a surface of the bottom sliding plate, each wing portion defines a hole to receive the first protrusions.

9. The sliding-type portable terminal of claim 1, wherein the cover further comprises a top housing and a top sliding plate, the top housing defines a cavity, the top sliding plate covers the cavity, and the first magnetic member is fixed to the top sliding plate.

10. The sliding-type portable terminal of claim 9, wherein the sliding-type portable terminal further comprises a second connecting member configured to receive the second magnetic member, the second connecting member is fixed to the top sliding plate.

11. The sliding-type portable terminal of claim 10, wherein the second connecting member is made of rubber.

12. The sliding-type portable terminal of claim 10, wherein the second connecting member further comprises two wing portions, the top sliding plate forms two second protrusions on a surface of the top sliding plate, each wing portion defines a hole to receive the second protrusions.

13. The sliding-type portable terminal of claim 1, wherein the driving mechanism comprises a first connecting end, a second connecting end opposite the first connecting end, and an elastic module connecting the first connecting end and the second connecting end, the first connecting end is fixed to the cover, and the second connecting end is fixed to the main body.

14. The sliding-type portable terminal of claim 1, wherein the cover is slidably engaged with the main body by sliding rails and sliding grooves slidably engaged with the sliding rails.

15. A sliding-type portable terminal, comprising:
a main body;
a cover slidably connected to the main body;
a driving mechanism connected to the main body and the cover, comprising:
an elastic module for driving the cover to slide relative to the main body;
a first magnetic member fixed on the main body; and
a second magnetic member fixed on the cover, wherein the first magnetic member and the second magnetic member are arranged in opposing polarities with respect to each other;
wherein when the cover is in a closed state, a magnetic attraction is generated between the first magnetic member and the second magnetic member, thus the cover securely engages with the main body.
